(19) United States
(12) Patent Application Publication
(10) Pub. No.: US 2009/0250889 A1
(43) Pub. Date: Oct. 8, 2009

(54) HAND TRUCK

(76) Inventor: Donald Palmore, Eureka, NV (US)

Correspondence Address: IAN F. BURNS & ASSOCIATES, 4790 Caughlin Parkway #701, RENO, NV, 89519-0907, US

(21) Appl. No.: 12/416,846

(22) Filed: Apr. 1, 2009

Related U.S. Application Data
(60) Provisional application No. 61/041,844, filed on Apr. 2, 2008.

(51) Int. Cl. B62B 3/00

(52) U.S. Cl. 280/47.21

(57) ABSTRACT

A hand truck is used for moving large objects. The hand truck includes a frame that has a pair of rails and several cross members that extend between the rails. A bracket is mounted to the frame and a first set of wheels are coupled to the frame. A second set of wheels are coupled to the bracket. Several primary handles are mounted to the frame. A first and a second lifting handle are pivotally coupled to the frame.

### CROSS REFERENCE TO RELATED APPLICATIONS

This application claims priority to U.S. provisional patent application Ser. No. 61/041,844, filed Apr. 2, 2009, the contents of which is herein incorporated by reference.

### FIELD OF THE INVENTION

This invention relates to hand trucks and, more particularly, to a four wheel hand truck or dolly that can be used to manually move large objects.

### BACKGROUND

Hand trucks and carts are used to assist an operator in manually moving large or heavy objects. Hand trucks have several wheels attached to a frame with a platform. The load is placed on the platform and the frame is pivoted backward to lift the load. The wheels allow the load to be rolled to the desired location.

Unfortunately, when the load is heavy, the operator may be required to exert large forces on the frame in order to lift or move the object. The application of excessive forces by the operator may result in fatigue or injury to the operator.

### SUMMARY OF AT LEAST ONE EMBODIMENT OF THE INVENTION

### Advantages

The various embodiments of the present invention may, but do not necessarily, achieve one or more of the following advantages:

provide a hand truck for moving large objects;

provide a hand truck that uses a lifting handle to reduce the forces necessary to lift the hand truck and any load carried by the hand truck;

provide a cart that uses a reclining mechanism to lower a load carried by the hand truck;

provide a cart that has steps to increase leverage when moving a load;

provide an apparatus for moving large objects that has improved ergonomics for the operator;

provide an apparatus for moving objects that has a self retracting lifting handle;

provide an apparatus for moving objects that can reduce stress on the operator; and

provide lift arms for a hand truck that are retained to the hand truck when not in use.

These and other advantages of the present invention may be realized by reference to the remaining portions of the specification, claims, and abstract.

### BRIEF DESCRIPTION OF AT LEAST ONE EMBODIMENT OF THE PRESENT INVENTION

In at least one embodiment, the present invention is directed to an apparatus that is used for moving an object. The hand truck includes a frame that has a pair of rails and several cross members that extend between the rails. Several wheels are mounted to the frame. Several primary handles are mounted to the frame. A lifting handle is mounted to the frame. The lifting handle has an arm pivotally attached to the frame.

In another embodiment, the present invention is directed to a cart. The cart includes a a frame defined by a first and second rail and several cross members extending between the rails. A bracket is mounted to the frame and a first set of wheels is coupled to the frame. A second set of wheels is coupled to the bracket. Several primary handles are mounted to the frame. A first and a second lifting handle are pivotally coupled to the frame.

In an additional embodiment, the present invention is directed to a hand truck. The hand truck includes a frame that has a pair of rails and several cross members connecting the rails. Means for rotational movement are coupled to the frame. Several primary handles are mounted to the rails. At least one lifting handle is pivotally coupled to the frame.

The above description sets forth, rather broadly, a summary of one embodiment of the more important features of the present invention so that the detailed description of certain embodiments of the invention that follows may be better understood and contributions of the present invention to the art may be better appreciated. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a front isometric view of a hand truck in accordance with the present invention.

FIG. 2 is substantially a rear isometric view of the hand truck of FIG. 1.

FIG. 3 is substantially a side view of the hand truck of FIG. 1.

FIG. 4 is substantially an enlarged side view of a portion of the hand truck of FIG. 1 showing features of the lifting handles.

FIG. 5 is substantially an enlarged rear isometric view of a portion of the hand truck of FIG. 1 showing features of the reclining or lowering mechanism.

FIG. 6 is substantially an enlarged side isometric view of a portion of the hand truck of FIG. 1 showing features of the reclining or lowering mechanism.

FIG. 7 is substantially a front view of an axle with locking pins.

FIG. 8 is substantially a side view of the hand truck of FIG. 1 shown in an upright position with a load.

FIG. 9 is substantially a side view of the hand truck of FIG. 1 carrying a load and showing the lifting handle in the extended position.

FIG. 10 is substantially a side view of the hand truck of FIG. 1 carrying a load in a fully reclined position.

### DESCRIPTION OF AT LEAST ONE EMBODIMENT OF THE PRESENT INVENTION

In the following detailed description of certain embodiments of the present invention, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Hand Truck

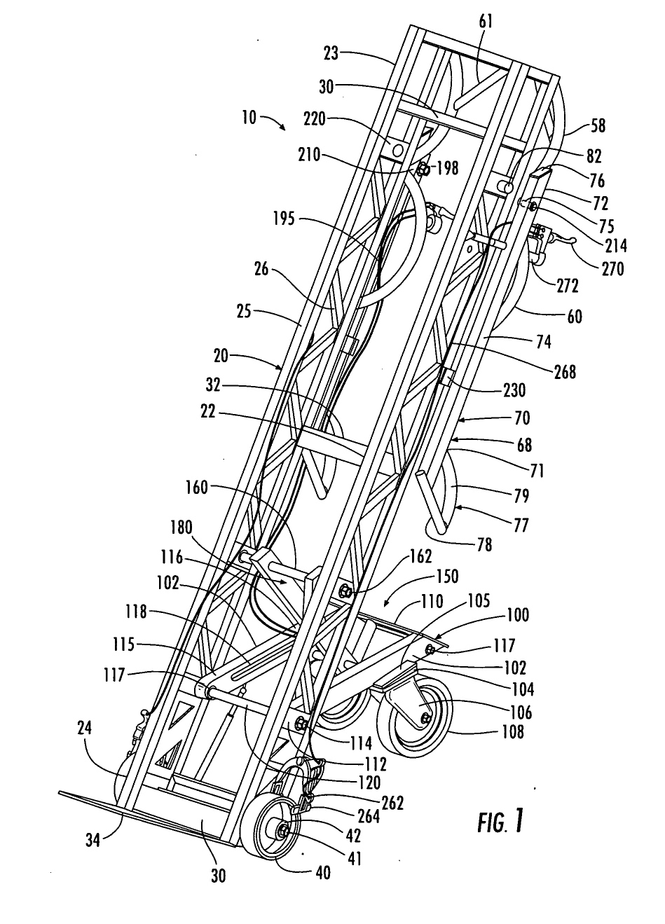

With reference to FIGS. 1-3, a hand truck assembly, hand cart or apparatus for moving objects 10 is shown. Hand truck assembly 10 may comprise a frame 20, front wheels 40, back wheel assembly 100, primary handles 58 and 60 and lifting handle assembly 68.

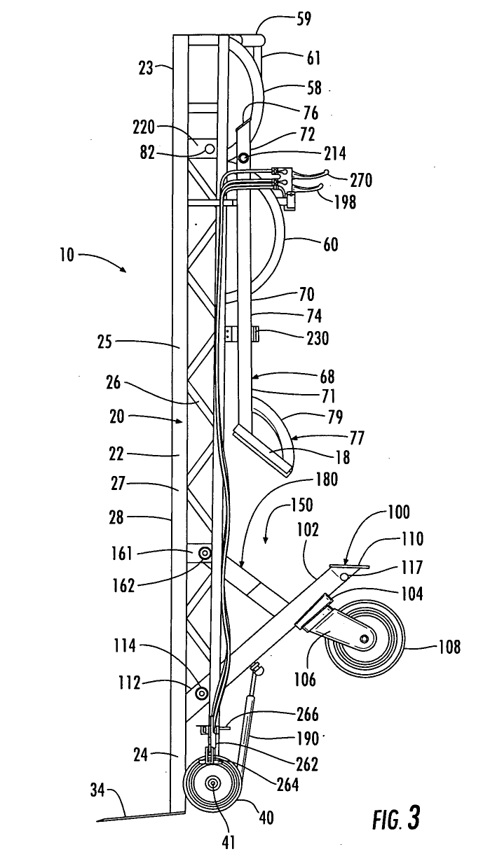

Frame 20 may have a pair of elongated generally parallel spaced apart rectangular shaped rails 22 that have ends 23 and 24. Frame 20 can be generally rectangular in shape. Each rail 22 is defined by a pair of elongated parallel tubes 25 that are held in a spaced apart relationship by diagonally extending support tubes 26. Rails 22 may have a front surface 27 (FIG. 3) that is covered with a rubber pad or covering 28 (FIG. 3). Rubber pad 28 can protect any objects carried by hand truck assembly 10 from damage.

Several cross members 30 may be attached between rails 22. Cross members 30 can be oriented generally perpendicular to rails 22 and can hold rails 22 in a spaced apart relationship. A central cross member or step 32 may be attached between rails 22. Step 32 may allow a user or operator to climb up frame 20.

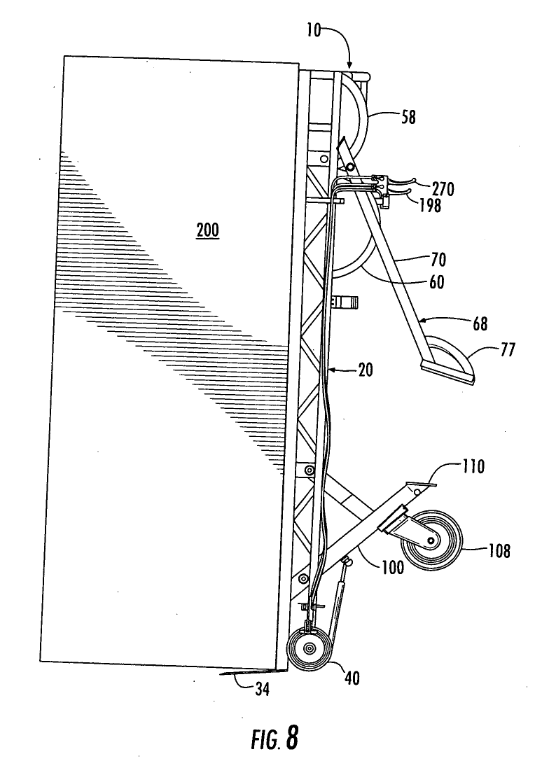

A generally rectangular load platform 34 is attached between rails 22 at end 24. Load platform 34 extends perpendicularly away from front surface 27. Frame 20 may be formed from metal such as steel or aluminum. The components of frame 20 may be welded, bolted or riveted together. A load 200, as shown in FIG. 8, that is to be moved such as a refrigerator or soda machine may be placed on load platform 34.

A pair of rotatable front wheels 40 may be mounted to each rail 22 toward end 24. A threaded axle or stud 41 can extend normally outward from tube 25. Wheels 40 may be retained to stud 41 by a fastener 42 such as a nut.

Back wheel assembly 100 can be attached to rails 22 toward end 24. Back wheel assembly 100 includes brackets 102, mounting plate 104, caster 106, wheel 108 and foot plate or step 110. Elongated channeled brackets or bars 102 maybe coupled for rotational movement to rails 22. Bracket 102 can have ends 115 and 116. An aperture 117 is defined in bracket 102 toward end 115. An elongated channel 118 may be defined in each bracket 102 along a side surface thereof. Channels 118 are parallel to and face each other on opposing sides of wheel assembly 100.

With continued reference to FIGS. 1-3, an axle support plate 112 can be attached to each of rails 22 in a relationship extending between tubes 25. Each end of axle 120 is threaded. An aperture (not shown) is defined in each support plate 112. An aperture 117 may extend through bracket 102 at end 115. Axle 120 extends between rails 22 and through apertures 117. The threaded ends of axle 120 further can extend through support plates 112. Fasteners 114 such as nuts may be attached to the threaded ends of axle 120 to retain axle 120 between rails 22. Brackets 102 are thereby coupled for rotary movement to frame 20 by axle 120.

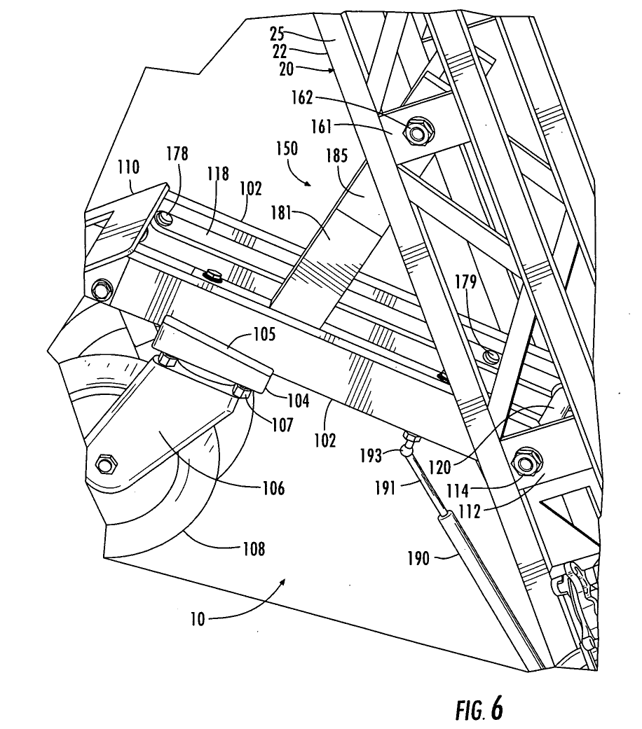

A mounting plate 104 can be attached to a lower side of each bracket 102 by suitable means such as welding. A rubber cover 105 may be attached to a top side of mounting plate 104 to protect mounting plate 104 from damage. Casters 106 are mounted to each mounting plate 104 using fasteners 107 (FIG. 6) such as nuts and bolts. Each caster 106 can be attached to a wheel 108 for rotary movement when wheel 108 is in contact with a ground surface. A foot plate 110 can be attached between brackets 102 at ends 116 using fasteners 117 such as nuts and bolts. Foot plate 110 may be oriented at angle with respect to brackets 102 such that foot plate 110 is in a horizontal position when hand truck 10 is in an upright position. A user may step on foot plate 110 during the use of hand truck 10.

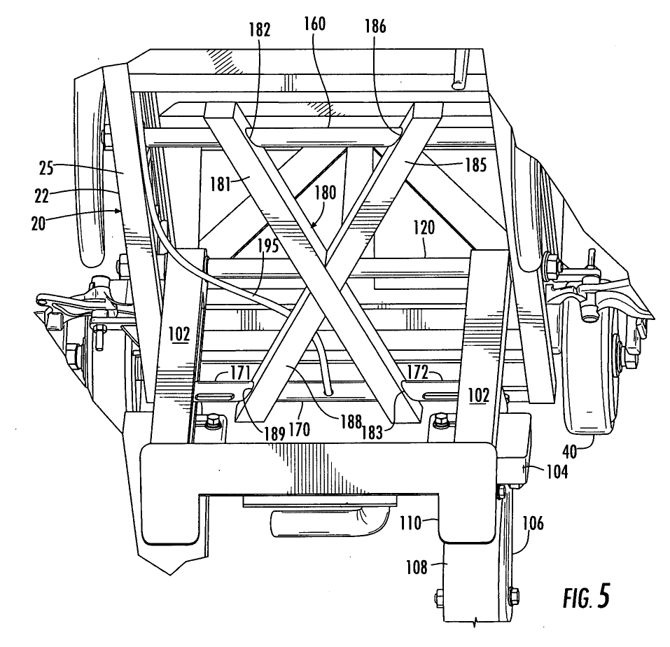

Turning now to FIGS. 5-7, a reclining or lowering mechanism or assembly 150 is shown. Reclining mechanism 150 can include upper axle 160, lower axle 170, cross-bars 180, gas strut 190, cable 195 and handle 198. Reclining mechanism 150 can allow an operator to raise or lower a load carried by hand truck 10.

Another axle support plate 161 can be attached to each of rails 22 in a relationship extending between tubes 25. Each end of axle 160 is threaded. An aperture (not shown) is defined in each support plate 161. Upper axle 160 is cylindrical in shape and can extend between support plates 161 in a generally perpendicular relationship. The threaded ends of axle 160 further can extend through the apertures of support plates 161. Fasteners 162 such as nuts may be attached to the threaded ends of axle 160 to retain axle 160 between rails 22.

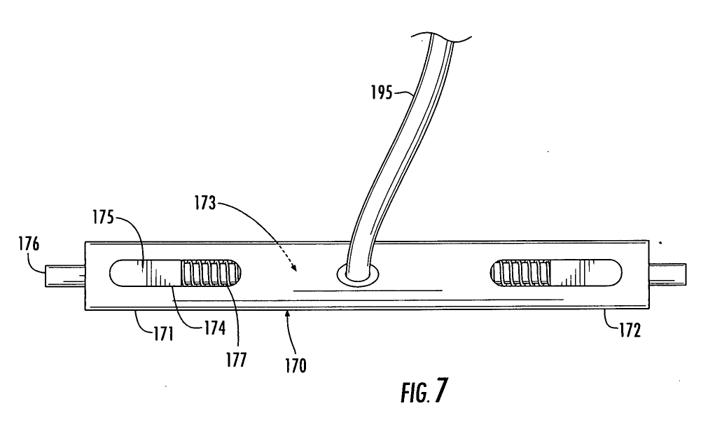

Lower axle 170 is cylindrical in shape and can extend between brackets 102 in a generally perpendicular relationship. With additional reference to FIG. 7, lower axle 170 has ends 171 and 172 and a hollow interior cavity 173. Two oval shaped openings 174 are defined in axle 170 and extend into cavity 173. Locking pins 175 may be retained within cavity 173. Locking pins 175 can have an end 176 that extends outwardly from ends 171 and 172 of axle 170. Two springs 177 may be mounted in cavity 173 adjacent to and in contact with locking pins 177. Springs 177 can push or force locking pins 175 outwardly from axle 170.

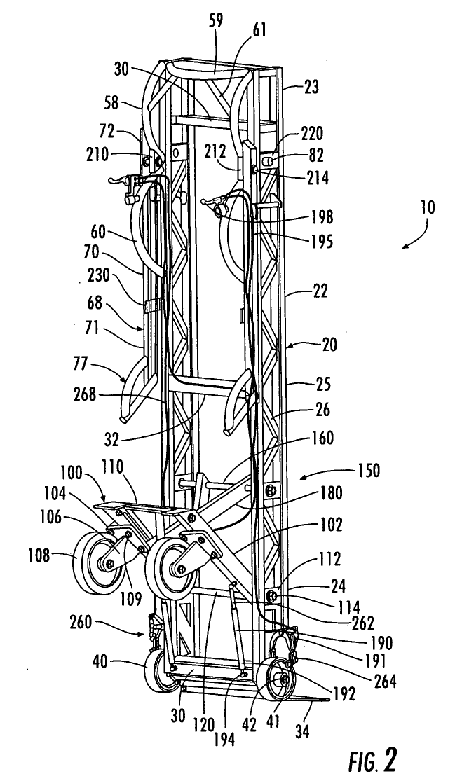

A mechanical cable 195 can extend into cavity 173 and be connected with locking pins 175 such that locking pins 175 may be retracted and extended by the actuation of cable 195. Cable 195 can be connected with a locking handle 198 (FIG. 2) that is mounted to one of primary handles 60. Handle 198 can actuate cable 195 and thereby allow an operator of hand truck 10 to extend and retract locking pins 175.

As seen in FIGS. 6 and 7, brackets 102 have channels 118. A circular bore 178 can be defined in each bracket 102 at one end of channel 118 and another circular bore 179 can be defined in each bracket 102 at the other end of channel 118. When locking pins 175 (FIG. 7) are in an extended position, ends 176 are located and extend into one of bores 178 or 179. When end 176 (FIG. 7) is coupled with bore 178 (FIG. 6), reclining mechanism 150 is locked into a fully upright position. When end 176 is coupled with bore 179, reclining mechanism 150 is locked into a fully lowered position. When locking pins 175 are in a retracted position fully within cavity 173, ends 171 and 172 of axle 170 are adapted for sliding movement within channel 118. Ends 171 and 172 can extend into channels 118 thereby retaining axle 170 to brackets 102.

Turning now to FIGS. 5 and 6, a pair of X-shaped metal cross-bars 180 maybe mounted for movement between axles 160 and 170. Cross-bars 180 include bars 181, 185 and 188. Bars 185 and 188 can be connected to bar 181 by a suitable means such as by welding. Apertures 182 and 183 may be defined in ends of bar 181. Aperture 186 is defined in one end of bar 185 and aperture 189 may be defined in one end of bar 188. Upper axle 160 may pass through apertures 182 and 186. Lower axle 170 may pass through apertures 183 and 189. X-shaped metal cross-bars 180 may rotate about axles 160 and 170 and can provide support between frame 20 and back wheel assembly 100 when hand truck 10 is reclined or lowered.

Referring to FIGS. 2 and 6, a pair of elongated gas springs or struts 190 can be mounted between a central portion of bracket 102 and lower cross-member 30. Gas strut 190 has ends 191 and 192. End 191 can be mounted to bracket 102 through a rotatable ball joint 193. End 192 can be mounted to lower cross-member 30 through a rotatable ball joint 194. Gas springs 190 help lift and counteract the weight of a load carried by hand truck 10 during raising and lowering of the load using reclining mechanism 150.

With reference to FIGS. 1-4, a pair of semi-circular shaped upper primary handles 58 may be attached to a lower side of rails 22 toward end 23 and more specifically attached to a tube 25. A pair of semi-circular shaped lower primary handles 60 may be attached to a lower side of rails 22 toward end 23 and more specifically attached to a tube 25. A semi-circular shaped center handle 59 may be connected between rails 22 at end 23. Braces 61 can be connected between center handle 59 and upper primary handles 58 to add additional strength. Handles 58, 59, 60 and braces 61 can be formed from metal.

Primary handles 58 and 60 and center handle 59 may be grasped by the hands of an operator in order to tilt, push or pull frame 20 and any load carried on load platform 34.

A lifting handle or lifting handle assembly 68 may be attached to frame 20 toward rail end 23. Lifting handle assembly 68 comprises a pair of elongated parallel lifting handles or arms 70. Arms 70 may have ends 71 and 72 and a center portion or section 74. An angled section or surface 76 is located at end 72. A hole 75 can extend through arm 70 toward end 72. A hand grip 77 is connected to arm 70 toward end 71. Hand grip 77 can comprise a straight angled section 78 and a curved section 79 that extends between angled section 78 and arm 70.

Trapezoidal shaped support tubes or members 210 can be attached between primary handles 58 and 60 using a suitable fastening technique such as welding. A hole 212 can extend through support member 210. Arms 70 are pivotally and rotatably retained to support members 210 by a fastener 214 such as a partially threaded bolt and a nut. Fasteners 214 extend through holes 75 of arm 70 and holes 212 of support member 210. Arms 70 can rotate about an axis formed by fastener 214.

A support plate 220 can be attached to each of rails 22 in a relationship extending between tubes 25 toward end 23. Circular posts 82 extend normally outwardly from each support plate 220. Posts 82 serve as a stop to limit the rotation of arms 70. When arm 70 is sufficiently extended, angled end 76 of arm 70 will contact post 82 stopping rearward movement of arm 70.

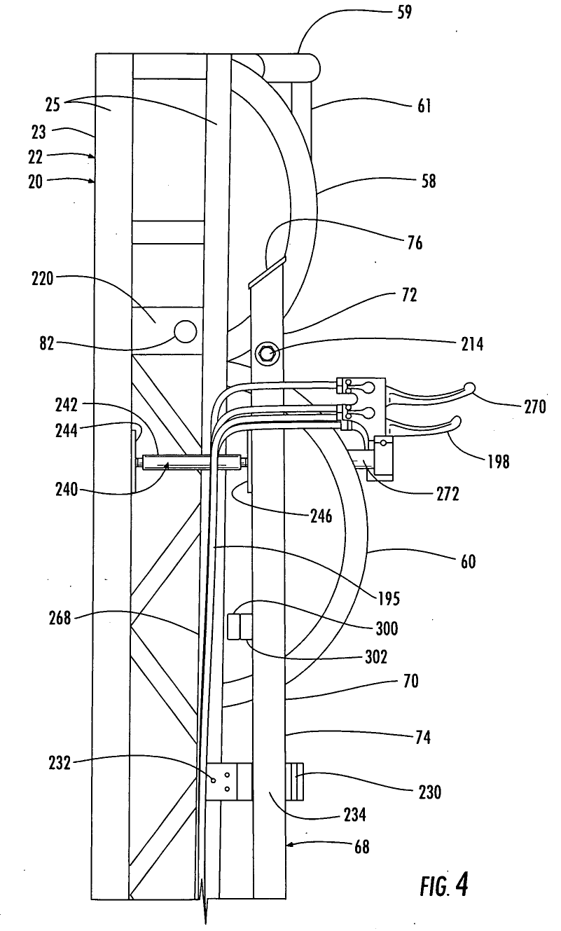

A pair of place holders or spring clips 230 can be attached to a bottom side of each of opposing rails 22. Spring clips 230 can be fastened to a tube 25 using a fastener 232 such as rivets or screws. Spring clips 230 may have a center recess 234 (FIG. 4) that is the same width as arms 70. Spring clips 230 may be biased slightly inwardly such that when arms 70 are moved to a retracted position, spring clips 230 are bent outwardly by arms 70 sliding over spring clips 230 until center recess 234 moves over arm 70. Arms 70 are then held in center recess 234. Spring clips 230 retain arms 70 in a retracted storage position against and parallel to rails 22 when not in use.

An elastic biasing mechanism 240 can be attached between each of rails 22 and arms 70. Biasing mechanism 240 can include elastic or rubber tubing 242 and brackets 244 and 246. Bracket 244 may be affixed to rail 22 on a lower side of tube 25. Bracket 246 may be affixed to a lower side of arm 70. Elastic tubing 242 such as surgical tubing is mounted and retained by and between brackets 244 and 246. As arms 70 rotate outwardly away from frame 20, elastic tubing 242 is stretched into an elongated position exerting a pulling force on arms 70. When arms 70 are in an extended position away from frame 20 and are released, elastic tubing 242 biases or causes arms 70 to rotate back toward frame 20 to a stored or resting position.

In an alternative embodiment, magnets 300 (FIG. 4) and 302 (FIG. 4) can used to retain arms 70 in a stored position against rails 22. One magnet 300 can be attached to rails 22 and another magnet 302 can be fastened to arm 70. The polarity of the magnets are arranged such that the magnets magnetically attract each other. The magnets can retain arms 70 in a retracted position against and parallel to rails 22 when not in use.

Hand grips 77 and arms 70 may be grasped by the hand of an operator in order to lift frame 20 and any load carried by hand truck 10 from a tilted position to an upright position.

With reference to FIGS. 1-4, hand truck assembly 10 can include braking apparatus 260. Braking apparatus 260 comprises brake calipers 262, brake pads 264, fastener 266, cables 268 and brake handle 270. Brake calipers 262 can be attached to opposing rails 22 toward end 24 by the use of fastener 266. Fastener 266 such as a bolt passes thorough tube 25 and is secured with a nut. A brake pad 264 is mounted to calipers 262 in a relationship whereby wheel 40 is located between brake pads 264.

Brake calipers 262 may be connected to one end of brake cables 268. Brake cables 268 are connected between brake calipers 262 and brake handle 270. Brake cables 268 extend along rails 22 from end 23 toward end 24. Brake handle 270 can be affixed to a post 272 that is welded to lower primary handle 60. When brake handle 270 is actuated, calipers 262 contract causing brake pads 264 to frictionally engage wheel 40 along a side surface causing slowing or stopping of hand truck 10. Braking mechanism 260 allows an operator of hand truck 10 to slow or stop hand truck 10 and any load.

Operation

With reference to FIGS. 8, 9 and 10, hand truck assembly or apparatus for moving objects 10 can be used to move a large heavy load 200 such as a soda dispensing machine, candy machine or other vending machine.

During use hand truck assembly 10 is positioned with load platform 34 slid to extend under the load 200 and rubber pad 28 (FIG. 3) adjacent to load 200. This position is an upright loaded position and is shown in FIG. 8.

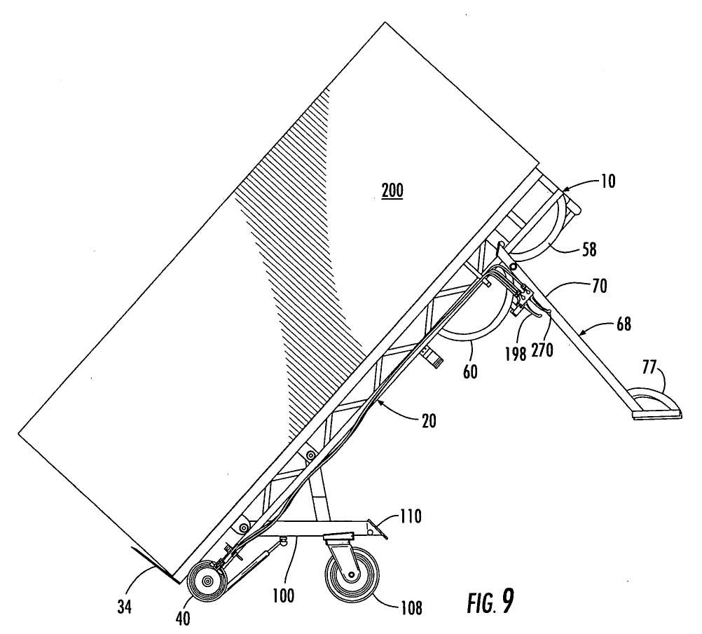

An operator may then grasp primary handles 58 and 60 and climb onto step 110. The operator may then lean backwards, causing the truck 10 and load 200 to pivot on front wheels 40. The hand truck and load may then continue to pivot until back wheels 108 contact the ground. Load 200 is now supported by all four wheels 40 and 108 as shown in FIG. 9. At this point load 200 may now be moved using all four wheels 40 and 108 to a desired location.

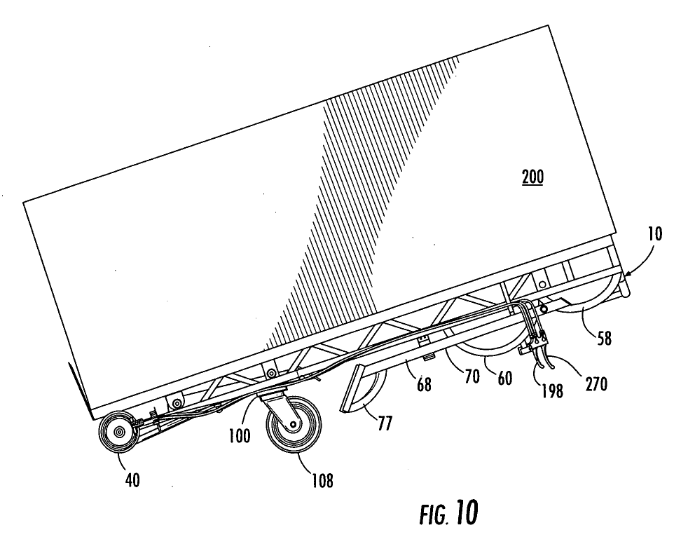

Load 200 may be further lowered or reclined using reclining mechanism 150 (FIG. 5). Depression of handle 198 causes locking pins 176 (FIG. 7) to disengage from bores 179 (FIG. 6) allowing axle 170 (FIG. 5) to slide along channels 118 (FIG. 6) causing frame 20 to be lowered to a lower or resting position as shown in FIG. 10. When handle 198 is released, locking pins 176 may then engage bores 179 locking frame 20 into the lower or reclining position.

To raise frame 20 from the lower position of FIG. 10, handle 198 is actuated causing locking pins 176 (FIG. 7) to disengage from bores 179 (FIG. 6). Load 200 may be raised by lifting on handles 58 and 59 back to the position shown in FIG. 9. When handle 198 is released, locking pins 176 may then engage bores 179 locking frame 20 into the upper position.

In order to return load 100 to an upright position, lifting handles 68 are used. An operator may pull on hand grips 77 causing lifting handles 68 or arms 70 to disengage from spring clips 230 (FIG. 4). Lift arms 70 can pivot about fastener 214 (FIG. 4) until angled surface 76 (FIG. 4) contacts post 82 (FIG. 4). Lifting handles 68 are shown in a fully extended position in FIG. 9. The operator may now apply force to the extended arms 70 by lifting upwardly to move load 100 back to an upright position as was shown in FIG. 8. The length of lifting handles 68 acting on frame 20 provides a long lever arm that reduces the amount of force necessary to move load 100 to an upright position. Lifting handles 68 thereby can reduce the amount of effort required by an operator using hand truck 10 and can improve the ergonomics of hand truck 10 during operation.

### CONCLUSION

Although the description above contains many specifications, these should not be construed as limiting the scope of the invention but as merely providing illustrations of certain embodiments of this invention. Thus, the scope of the invention should be determined by the appended claims and their legal equivalents rather than by the examples given.

What is claimed is:

1. An apparatus for moving an object comprising:
(A) a frame having a pair of rails and a plurality of cross members extending between the rails;
(B) a plurality of wheels mounted to the frame;
(C) a plurality of primary handles mounted to the frame; and
(D) at least one lifting handle mounted to the frame, the lifting handle having an arm pivotally attached to the frame.

2. The apparatus of claim 1, wherein the arm has a first end and a second end, the first end pivotally attached to the frame and the second end having a hand grip.

3. The apparatus of claim 1, wherein a post is mounted to the frame, the lifting handle engaging the post when the lifting handle is in an extended position.

4. The apparatus of claim 1, wherein the lifting handle is retained to the frame when the lifting handle is in a stored position.

5. The apparatus of claim 1, wherein a magnet retains the lifting handle to the frame when the lifting handle is in a stored position.

6. The apparatus of claim 1, wherein a wheel assembly is mounted to the frame.

7. The apparatus of claim 6, wherein the wheel assembly has at least one step.

8. A cart comprising:
(A) a frame defined by a first and second rail and a plurality of cross members extending between the rails;
(B) a bracket mounted to the frame;
(C) a first set of wheels coupled to the frame;
(D) a second set of wheels coupled to the bracket;
(E) a plurality of primary handles mounted to the frame; and
(F) a first and a second lifting handle pivotally coupled to the frame.

9. The cart of claim 8, wherein at least one post is mounted to the frame, the lifting handles engaging the post when the lifting handles are in an extended position.

10. The cart of claim 8, wherein the lifting handles are pivotally attached to the rails.

11. The cart of claim 8, wherein the lifting handles are retained to the frame when the lifting handle is in a stored position.

12. The cart of claim 8, wherein the bracket has at least one step.

13. The cart of claim 8, wherein a load is adapted to be carried by the frame, the lifting handles being adapted to move the load from a first position to a second position.

14. A hand truck comprising:
(A) a frame having a pair of rails and a plurality of cross members connecting the rails;
(B) means for rotational movement coupled to the frame;
(C) a plurality of primary handles mounted to the rails; and
(D) at least one lifting handle pivotally coupled to the frame.

15. The hand truck of claim 14, wherein the lifting handle is configured for movement from a retracted stored position to an extended lifting position.

16. The hand truck of claim 14, wherein at least one post is mounted to the frame, the lifting handle engaging the post when the lifting handle is in an extended position.

17. The hand truck of claim 14, further comprising at least two lifting handles pivotally coupled to the frame.

18. The hand truck of claim 14, wherein the means for rotational movement further comprises a first set of wheels attached to the frame and a bracket attached to the frame, a second set of wheels being attached to the bracket.

19. The hand truck of claim 14, wherein the frame has at least one step.

20. The hand truck of claim 14, wherein a load is adapted to be carried by the frame, the lifting handles being adapted to move the load from a first position to a second position.
